(19) United States
(12) Patent Application Publication
(10) Pub. No.: US 2009/0259780 A1
(43) Pub. Date: Oct. 15, 2009

(54) Portable electronic device for controlling under-controlled devices

(75) Inventor: Wei Hsu, Taipei (TW)

Correspondence Address: BACON & THOMAS, PLLC, 625 SLATERS LANE, FOURTH FLOOR, ALEXANDRIA, VA, 22314-1176, US

(73) Assignee: Weistech Technology Co., LTD., Chung Ho City (TW)

(21) Appl. No.: 12/081,060

(22) Filed: Apr. 10, 2008

(51) Int. Cl. G06F 13/12

(52) U.S. Cl. 710/63

(57) ABSTRACT

The present invention provides a portable electronic device for controlling an under-controlled device. The portable electronic device includes a chip, a firmware formed within the chip to support the under-controlled device, a decoder coupled to the chip to transform command signals from a portable electronic device protocol to an under-controlled device protocol, an accessory controller coupled to the decoder, a portable electronic device output interface coupled to the chip to output the command signals to the under-controlled device, a keypad coupled to the chip and formed on the portable electronic device.

### FIELD OF THE INVENTION

The present invention relates to a portable electronic device, and more particularly to a portable electronic device for controlling an under-controlled device.

### BACKGROUND OF THE INVENTION

In recent years, consumer electronic products develop very fast. Brand new products are continuously developed by the consumer electronics industry, for example digital cameras with more pixels and mobile phones capable of listening MP3 music files, watching MP4 or AVI video files, taking photographs, or playing 3D games, to attract consumers. However, the keypad or buttons of the consumer electronic products decrease the convenience of usage by the user when the small consumer electronic products have more built-in functions. The keypad or buttons of conventional consumer electronic products are quite tiny to the user. The user has to press the keypad continuously to input text messages, edit photographs, or select specific items to perform specific functions. Therefore, the conventional consumer electronic products are inconvenient for the user to use. Accordingly, there is still a demand for a device capable of solving aforementioned problems to increase the convenience of using consumer electronic products.

### SUMMARY OF THE INVENTION

In view of the aforementioned defects of the conventional consumer electronic products, the present invention discloses a portable electronic device for controlling an under-controlled device.

In one aspect of the present invention, a portable electronic device for controlling an under-controlled device at least includes a chip; a firmware formed in the chip to support the under-controlled device; a decoder coupled with the chip to transform command signals from a portable electronic device protocol to an under-controlled device protocol; an attachment controller coupled with the decoder; and a portable electronic device output interface coupled with the chip to output the command signals to the under-controlled device. The portable electronic device output interface may include a BLUETOOTH standard module, an IEEE1394, and a universal serial bus which includes a Type A universal serial bus, a Type B universal serial bus, a Type Mini A universal serial bus, a Type Mini B universal serial bus, or a Type Mini AB universal serial bus. The portable electronic device includes a mouse. In one aspect of the present invention, the portable electronic device may include a keypad coupled with the chip and formed on the portable electronic device. The keypad may include a plurality of keys with numbers and English letters to input text or number messages immediately.

One advantage of the present invention is that the portable electronic device can connect any kinds of under-controlled devices wiredly or wirelessly to control them.

Another advantage of the present invention is that the portable electronic device can have a plurality of keys with numbers and English letters thereon to input text or number messages immediately.

These and other advantages will become apparent from the following description of preferred embodiments taken together with the accompanying drawings and the appended claims.

### BRIEF DESCRIPTION OF THE DRAWINGS

The present invention may be understood by some preferred embodiments and detailed descriptions in the specification and the attached drawings below. However, it should be appreciated that all the preferred embodiments of the invention are only for illustrating but not for limiting the scope of the Claims and wherein:

FIG. 1 is a schematic diagram of a portable electronic device in accordance with the present invention;

FIG. 2 is a block diagram of the portable electronic device in accordance with the present invention;

FIG. 3 is a block diagram of a mobile phone with a portable electronic device input interface in accordance with the present invention;

FIG. 4 is an architecture diagram of a graphic user interface in accordance with the present invention; and

FIG. 5 is a system architecture diagram of Java 2 Platform, Micro Edition (J2ME) in accordance with the present invention.

### DETAILED DESCRIPTION OF THE PREFERRED EMBODIMENT

The invention will now be described with the preferred embodiments and aspects and these descriptions interpret structure and procedures of the invention only for illustrating but not for limiting the Claims of the invention. Therefore, except the preferred embodiments in the specification, the present invention may also be widely used in other embodiments.

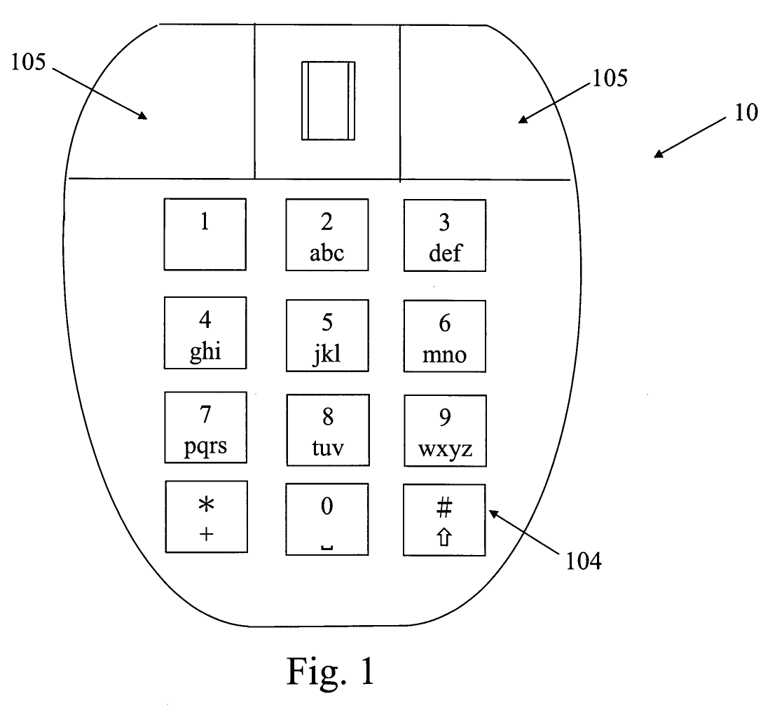

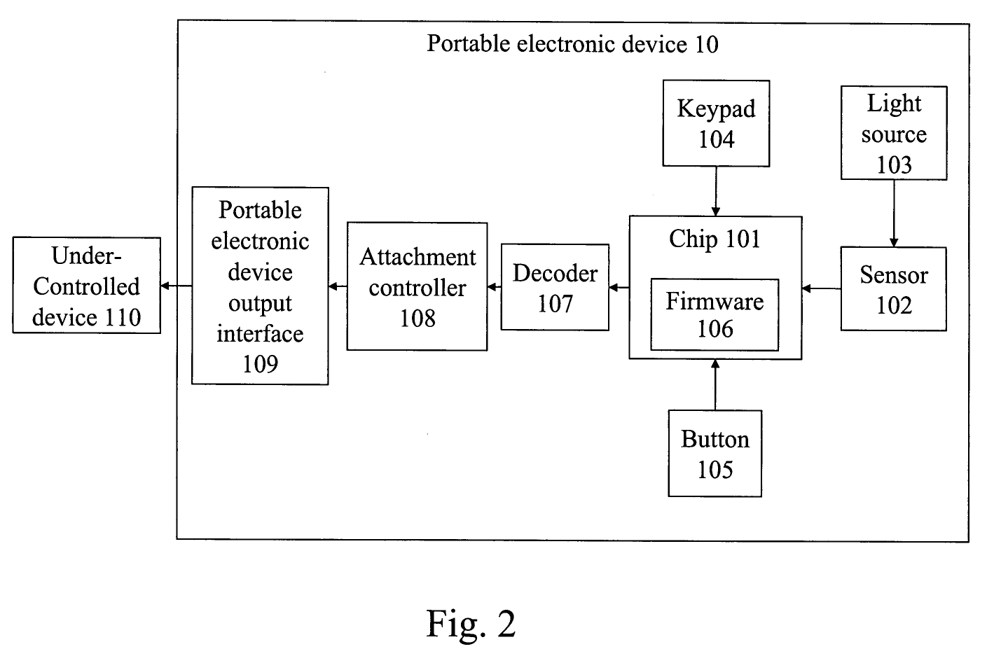

In one embodiment of the present invention, the present invention discloses a portable electronic device for controlling an under-controlled device. In one embodiment of the present invention, the portable electronic device for controlling an under-controlled device may be a mouse, as shown in FIG. 1. The portable electronic device 10 may optionally include a keypad 104 and buttons 105 formed on the main body. Furthermore, in one embodiment of the present invention, the keypad 104 includes a plurality of keys with numbers and English letters to input text or number messages immediately. As shown in FIG. 2, the portable electronic device 10 includes a chip 101, a sensor 102, a light source 103, a keypad 104, buttons 105, a decoder 107, an attachment controller 108 and a portable electronic device output interface 109. In one embodiment, the portable electronic device output interface 109 may be a wired or wireless interface including but not being limited to a BLUETOOTH standard module, a universal serial bus (USB), and an IEEE1394. The universal serial bus (USB) includes but is not limited to a Type A universal serial bus (USB), a Type B universal serial bus (USB), a Type Mini A universal serial bus (USB), a Type Mini B universal serial bus (USB), and a Type Mini AB universal serial bus (USB). As shown in FIG. 2, the chip 101 includes a firmware 106. It should be appreciated that the firmware 106 can be updated by being downloaded from Internet to support an under-controlled device 110, for instance a mobile phone, a global positioning system (GPS) device, a personal digital assistant (PDA) or a digital camera, connected with the portable electronic device 10 through the portable electronic device output interface 109, as shown in FIG. 2. In one embodiment, the driver of the portable electronic device 10 can be installed by the user or be built-in in the under-controlled device 110, such as a mobile phone or a digital camera, connected with the portable electronic device 10, so as to read or decode command signals from the portable electronic device 10. The command signals of the portable electronic device 10 is transformed by the decoder 107 from a portable electronic device protocol, for example a mouse protocol, to an under-controlled device protocol, for example a mobile phone protocol, to control the under-controlled device 110 coupled via the portable electronic device output interface 109 through the attachment controller 108. Therefore, the portable electronic device 10 outputs the transformed command signals through the decoder 107, the attachment controller 108 and the portable electronic device output interface 109 to the under-controlled device 110, for example a mobile phone or a digital camera, connected with the portable electronic device 10, thereby controlling the under-controlled device 110. In one embodiment, the attachment controller 108 of the present invention may be embedded in or disposed outside of the portable electronic device 10. Similarly, the decoder 107 of the present invention may be embedded in or disposed outside of the portable electronic device 10. In one embodiment, the decoder 107 transforms the command signals of the portable electronic device 10 into command signals recognizable to the under-controlled device 110. In one embodiment, the attachment controller 108 may be a game controller for controlling built-in games in the under-controlled device 110. Accordingly, the present invention provides the portable electronic device 10 for controlling the under-controlled device 110.

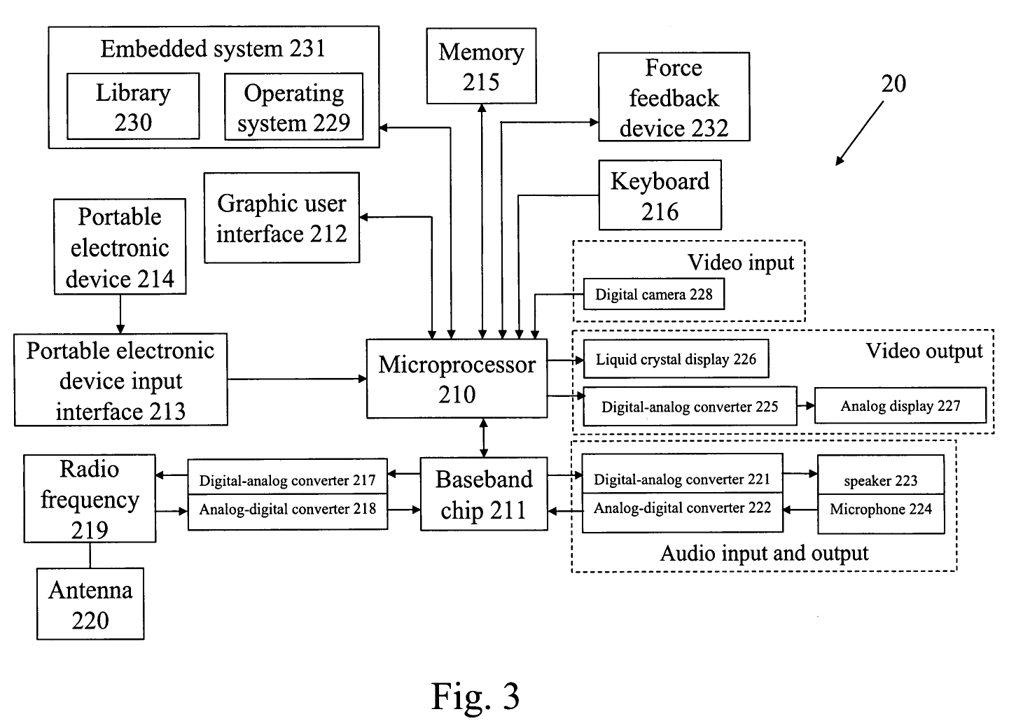

With reference to FIG. 3, a mobile phone is taken as an example of the under-controlled device 110 in the following descriptions to illustrate the present invention. Other examples of the under-controlled device 110, for instance, a digital camera, a global positioning system (GPS) device and a personal digital assistant (PDA) may be performed on the same principle. In one embodiment of the present invention, a mobile phone 20 primarily includes a microprocessor (MPU) 210, a baseband chip 211, a graphic user interface (GUI) 212, a portable electronic device input interface 213, a portable electronic device 214, a memory 215, a keypad 216, an embedded system 231 and a force feedback device 232. Moreover, the mobile phone 20 further includes a digital-analog converter 217, an analog-digital converter 218, a radio frequency 219 and an antenna 220, so as to utilize the digital-analog converter 217 to convert digital data signals outputted from the baseband chip 211 into analog data signals to transmit the analog data signals wirelessly through the radio frequency 219 and the antenna 220 to an exterior device, and to utilize the analog-digital converter 218 to convert analog data signals received wirelessly by the radio frequency 219 through the antenna 220 from the exterior device into digital data signals to transmit the digital data signals to the baseband chip 211. The mobile phone 20 also includes a digital-analog converter 221, an analog-digital converter 222, a speaker 223 and a microphone 224, so as to utilize the digital-analog converter 221 to convert digital audio signals outputted from the baseband chip 211 into analog audio signals to output through the speaker 223, and to utilize the analog-digital converter 222 to convert analog audio signals received by the microphone 224 into digital audio signals to transmit the digital audio signals to the baseband chip 211.

The mobile phone 20 also includes a digital-analog converter 225, a liquid crystal display 226, an analog display 227 and a digital camera 228, so as to transmit digital video signals captured by the digital camera 228 to the microprocessor 210, and to utilize the digital-analog converter 225 to convert digital video signals outputted from the microprocessor 210 into analog video signals to output through the analog display 227 or to output the digital video signals outputted from the microprocessor 210 directly through the liquid crystal display 226. The mobile phone 20 further includes an operating system 229. In one embodiment, the microprocessor 210 includes an Advanced RISC Machine (ARM). The digital audio signals, the digital video signals, the digital data signals or any other information are stored in the memory 215 which includes a flash memory, a random access memory (RAM), a memory card or any other types of known memories. The portable electronic device input interface 213 includes a universal serial bus (USB), for example Type A universal serial bus (USB), a Type B universal serial bus (USB), a Type Mini A universal serial bus (USB), a Type Mini B universal serial bus (USB) and a Type Mini AB universal serial bus (USB), and a IEEE 1394.

The mobile phone 20 utilizes the portable electronic device 214, for example the specific mouse or mini keypad of the present invention, coupled with the microprocessor 210 through the portable electronic device input interface 213 in cooperation with the embedded system 231 designed for the keypad 216 and the portable electronic device 214 to command every components of the mobile phone 20 such as the graphic user interface (GUI) 212 or nongraphic user interfaces, for instance the force feedback device 232 to further control the mobile phone 20 to perform specific functions. It should be noted that the graphic user interface (GUI) 212 and the force feedback device 232 are utilized to illustrate but not to limit the present invention. The embedded system 231 includes an operating system (OS) 229 and a library 230 including for example device drivers. In one embodiment, the device drivers include drivers of the portable electronic device 214 and the keypad 216. The graphic user interface (GUI) 212 may be an embedded graphic user interface, which provides an interaction interface in a specific occasion for the embedded system 231. The embedded system 231 is a special-purpose computer system embedded as a part of a complete device and designed to perform one or a few dedicated functions. In contrast to a general-purpose computer system of a personal computer, the embedded system 231 usually executes predefined tasks with specific requirements. Since the embedded system 231 is dedicated to specific tasks, design engineers can optimize it by reducing the size and cost of the product or increasing the reliability and performance. The embedded system 231 is generally mass-produced, benefiting from economies of scale. The embedded graphic user interface needs to be simple, intuitive and reliable, occupy less resource, and respond fast to accommodate itself to limited hardware resources in the embedded system. Furthermore, because of special hardware in the embedded system, the embedded graphic user interface must have high portability and high cuttability to accommodate itself to different hardware conditions and usage requirements. Altogether, the embedded graphic user interface has several advantages of small size, consuming less system resource when in operation, hardware independence of the upper layer, high portability, high reliability, and real time in some occasions.

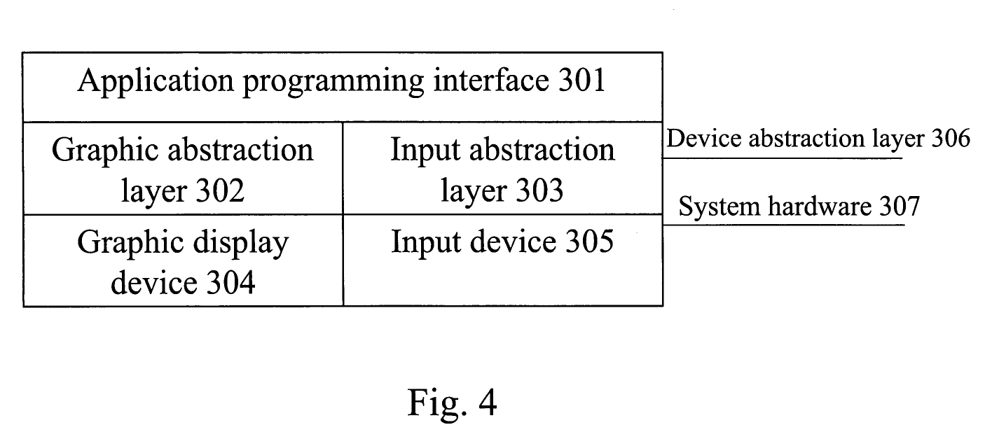

The embedded graphic user interface portable onto many hardware platforms applies at least two abstraction layers. One is a graphic abstraction layer (GAL) based on a graphic display device such as a display card or a liquid crystal display 226 while another is an input abstraction layer (IAL) based on an input device such as a portable electronic device 214 and a keypad 216. The graphic abstraction layer (GAL) completes the operation to specific display hardware device by the system and hides the details of performing techniques of several different hardware substantially to provide a unified graphic programming interface for program developer. The input abstraction layer (IAL) performs the control operation to several different input devices to provide a unified invocation interface. The design of the graphic abstraction layer (GAL) and the input abstraction layer (IAL) can highly increase the portability of the embedded graphic user interface, as shown in FIG. 4.

FIG. 4 is a diagram of the graphic user interface (GUI) in accordance with one embodiment of the present invention. The graphic user interface basically includes three layers, wherein a graphic display device 304 and an input device 305 in the bottom layer may be the drivers for the plane-oriented graphic display, such as the liquid crystal display 226 or the analog display 227, the portable electronic device 214, and the keypad 216. A graphic abstraction layer (GAL) 302 and an input abstraction layer (IAL) 303 in the middle layer provides abstract interfaces of the hardware in the bottom layer and perform window management while an application programming interface (API) 301 in the top layer provides an application programming interface compatible to the operating system.

The bottom layer support library 230 in the core of the embedded system 231 is firstly activated to implant the embedded graphic user interface. Subsequently, the embedded graphic user interface is configured to select the graphic abstraction layer (GAL) engine, so as to utilize the bottom layer support library as a graphic generating engine of the embedded graphic user interface. The input abstraction layer (IAL) 303 of the embedded graphic user interface maps an input event of the input device 305 finally as a message event in the application programming interface (API) layer of the embedded graphic user interface. The input abstraction layer (IAL) 303 impliedly processes the input operations of the two devices: the keypad 216 device and the portable electronic device 214. The keypad 216 device provides different keypad input information upwards while the portable electronic device 214 provides messages of Click, ButtonUp and ButtonDown coordinates. When the embedded graphic user interface and the input device driving interface are performed, the actions of the input device are obtained by selection and converted into messages in the message queue. Corresponding to the liquid crystal display controller, part of the drivers must be encoded into the core statically, so as to activate the device by activating parameters transmitted into the core when the system operates. After being performed, the drivers of the keypad 216 and the portable electronic device 214 such as a mouse serve as the system core module to be loaded dynamically when in use.

The graphic user interface (GUI) may be programmed in different language platforms, for example Java 2 Platform, Micro Edition (J2ME) of Java language, which offers great tools for developers and ports the Java platform's network-centric and platform-agnostic worldview down to memory- and processor-limited devices. The J2ME architecture is based on families and categories of devices. A category defines a particular kind of device; cellular telephones, simple pagers, and organizers are separate categories. A family of devices is made up of a group of categories that have similar requirements for memory and processing power. Together, cellular phones, simple pagers, and simple personal organizers make up a single family of small-footprint devices. In order to support the kind of flexibility and customizable deployment demanded by the family of resource-constrained devices, the J2ME architecture is designed to be modular and scalable. This modularity and scalability is defined by J2ME technology in a complete application runtime model, with four layers of software built upon the host operating system of the device.

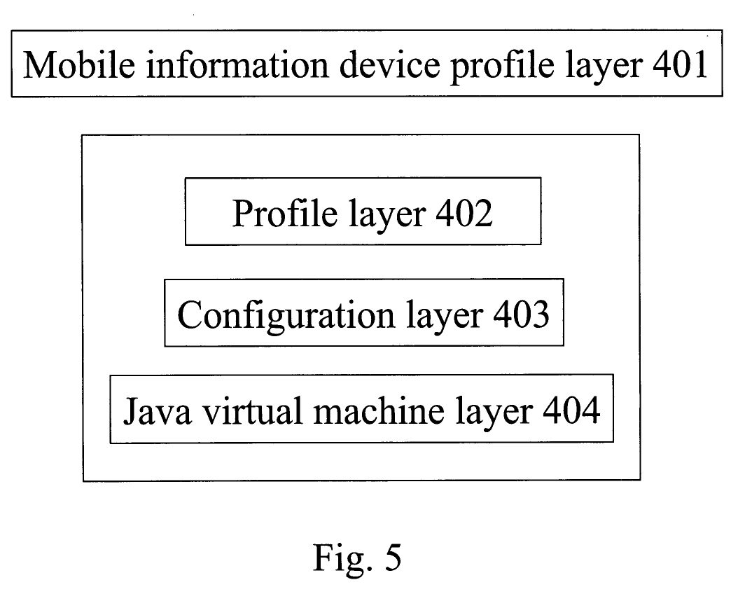

As shown in FIG. 5, the J2ME architecture includes a Java virtual machine layer 404, which is an implementation of a Java Virtual Machine that is customized for a particular device's host operating system and supports a particular J2ME configuration. The J2ME architecture further includes a configuration layer 403, which defines the minimum set of Java Virtual Machine features and Java class libraries available on a particular category of devices. In a way, a configuration defines the commonality of the Java platform features and libraries that developers can assume to be available on all devices belonging to a particular category. This layer is less visible to users, but is very important to profile implementers. Furthermore, the J2ME architecture includes a profile layer 402, which defines the minimum set of application programming interfaces (APIs) available on a particular family of devices. Profiles are implemented upon a particular configuration. Applications are written for a particular profile and are thus portable to any device that supports that profile. A device can support multiple profiles. This is the layer that is most visible to users and application providers. The J2ME architecture further includes a mobile information device profile layer 401, which is a set of Java APIs that addresses issues such as user interface, persistence storage, and networking.

As aforementioned, in one embodiment, the present invention provides the mobile phone 20 with the portable electronic device input interface to be controlled by the portable electronic device 214 by coupling the microprocessor 210 in the mobile phone 20 with the portable electronic device 214 and utilizing the embedded system 231 designed for the portable electronic device 214, such as a mouse, and a keypad 216. The embedded system 231 in the mobile phone 20 may have corresponding drivers to support the portable electronic device 214 and the keypad 216. Because the graphic user interface 212 is also designed for the portable electronic device 214 and the keypad 216, the graphic user interface 212 of the mobile phone 20 includes more items such as cursors, windows, scroll bars and pull-down menus except items corresponding to the keypad 216, so as to utilize the portable electronic device 214 to control, click, and drag. Therefore, the portable electronic device 214 can command every components for example the graphic user interface 212 or the force feedback device 232 of the under-controlled device 110 such as the mobile phone 20 to render the under-controlled device 110 to perform specific functions, for instance listening radio programs and MP3 or 3GP music files, watching AVI or 3GP video files, reading TXT text files, typing short messages, playing built-in games, performing video talks, surfing the internet, editing photographs, or modifying memorandums, in order for the user to utilize the under-controlled device more flexibly. Accordingly, the portable electronic device 214 can facilitate the user to utilize every function of the under-controlled device more conveniently.

The foregoing description is a preferred embodiment of the present invention. It should be appreciated that this embodiment is described for purposes of illustration only, not for limiting, and that numerous alterations and modifications may be practiced by those skilled in the art without departing from the spirit and scope of the invention. It is intended that all such modifications and alterations are included insofar as they come within the scope of the invention as claimed or the equivalents thereof.

What is claimed is:

1. A portable electronic device for controlling an under-controlled device, at least comprising:
a chip;
a firmware formed in said chip to support said under-controlled device;
a decoder coupled with said chip to transform command signals from a portable electronic device protocol to an under-controlled device protocol;
an attachment controller coupled with said decoder; and
a portable electronic device output interface coupled with said chip to output the command signals to said under-controlled device.

2. The device of claim 1, further comprising a keypad coupled with said chip and formed on said portable electronic device.

3. The device of claim 2, wherein said keypad comprises a plurality of keys with numbers and English letters to input text or number messages immediately.

4. The device of claim 1, wherein said portable electronic device output interface comprises a BLUETOOTH standard module.

5. The device of claim 1, wherein said portable electronic device output interface comprises an IEEE1394.

6. The device of claim 1, wherein said portable electronic device output interface comprises a universal serial bus.

7. The device of claim 6, wherein said universal serial bus comprises a Type A universal serial bus, a Type B universal serial bus, a Type Mini A universal serial bus, a Type Mini B universal serial bus, or a Type Mini AB universal serial bus.

8. The device of claim 1, wherein said portable electronic device comprises a mouse.

9. The device of claim 1, wherein said under-controlled device comprises a digital camera.

10. The device of claim 1, wherein said under-controlled device comprises a mobile phone.

11. The device of claim 1, wherein said under-controlled device comprises a global positioning system device.

12. The device of claim 1, wherein said under-controlled device comprises a personal digital assistant.

13. A portable electronic device for controlling an under-controlled device, at least comprising:
a chip;
a firmware formed in said chip to support said under-controlled device;
a decoder coupled with said chip to transform command signals from a portable electronic device protocol to an under-controlled device protocol; and
a portable electronic device output interface coupled with said chip to output the command signals to said under-controlled device.

14. The device of claim 13, further comprising a keypad coupled with said chip and formed on said portable electronic device.

15. The device of claim 14, wherein said keypad comprises a plurality of keys with numbers and English letters to input text or number messages immediately.

16. The device of claim 13, further comprising an attachment controller coupled with said decoder.

17. The device of claim 13, wherein said portable electronic device output interface comprises a BLUETOOTH standard module.

18. The device of claim 13, wherein said portable electronic device output interface comprises an IEEE1394.

19. The device of claim 13, wherein said portable electronic device output interface comprises a universal serial bus.

20. The device of claim 19, wherein said universal serial bus comprises a Type A universal serial bus, a Type B universal serial bus, a Type Mini A universal serial bus, a Type Mini B universal serial bus, or a Type Mini AB universal serial bus.

21. The device of claim 13, wherein said portable electronic device comprises a mouse.

22. The device of claim 13, wherein said under-controlled device comprises a digital camera.

23. The device of claim 13, wherein said under-controlled device comprises a mobile phone.

24. The device of claim 13, wherein said under-controlled device comprises a global positioning system device.

25. The device of claim 13, wherein said under-controlled device comprises a personal digital assistant.
